(19) United States
(12) Patent Application Publication
(10) Pub. No.: US 2024/0108171 A1
(43) Pub. Date: Apr. 4, 2024

(54) SYSTEM AND METHOD FOR MANAGING GREASE FROM FOODSTUFF DURING PREPARATION

(71) Applicant: Edmund A. Stanczak, Saint Clair Shores, MI (US)

(72) Inventor: Edmund A. Stanczak, Saint Clair Shores, MI (US)

(21) Appl. No.: 18/375,076

(22) Filed: Sep. 29, 2023

Related U.S. Application Data
(60) Provisional application No. 63/411,947, filed on Sep. 30, 2022.

(51) Int. Cl. A47J 37/10; A47J 36/34; A47J 45/06

(52) U.S. Cl. CPC A47J 37/108; A47J 36/34; A47J 45/061

(57) ABSTRACT

A system for managing grease from foodstuff during preparation in a frying pan is disclosed. The system includes a frying pan, a frying pan supporting structure, and an optional but preferred shield. The frying pan includes an underside having an extension integrally formed therewith. The frying pan supporting structure includes a bottom side for placement on a heating element and a top side upon which the frying pan rests. The frying pan extension nests within the top side of the supporting structure. The bottom side and the top side of the supporting structure are angled with respect to each other. The liquid, typically in the form of oil or grease in flowing form, substantially collects under the optional shield which prevents the splattering and splashing of oil and hot grease not only on the user but on nearby surfaces such as the stovetop, the adjacent wall, and the floor.

### CROSS-REFERENCE TO RELATED APPLICATION

This application claims the benefit of U.S. Provisional Patent Application Ser. No. 63/411,947 entitled “System and Method for Managing Grease from Foodstuff During Preparation” filed Sep. 30, 2022, which is herein incorporated by reference in its entirety for all purposes.

### DESCRIPTION OF THE INVENTION

### Technical Field

The disclosed invention relates generally to a system and method for managing grease and other cooking liquids generated from foodstuff during preparation in a frying pan. More particularly, the disclosed invention relates to a pan having an extension integrally formed on its underside which substantially nests within the upper surface of an angled supporting structure. The supporting structure is placed on a heating surface for supporting a frying pan. The optional shield is placed in the lowest area of the frying pan to restrict both splattering and splashing of the grease or other liquid.

### BACKGROUND OF THE INVENTION

It is well known that too much oil and fat in the diet is unhealthy. It is also well known that much of the oil and fat in the diet is the result of consuming foodstuff, such as hamburger meat, fried in a frying pan. In general cooking oil is placed on the frying pan. During the denaturing process involved in cooking meat it is normal for grease to be released. The combined residual cooking oil and grease tend to well in the bottom of the flat pan. The oil and grease is then taken up with the foodstuff when it is removed from the pan.

In an effort to control the amount of oil and fat in the diet, makers of cooking utensils have provided a variety of approaches to reducing the amount of oil and fat actually residual on the foodstuff. Today's cook has dealt with the problem of excess oil and grease in the pan using a variety of conventional methods. Paper towels, for example, have been used to absorb the oil and grease. It is also common for cooks to loosely place the pan cover over the frying pan followed by tilting of the cover-pan combination to allow excess oil and grease to drain away. Pasta colanders have been used for draining the oil and grease and metal racks have also been used to allow the oil and grease of the foodstuff to drain off. Some cooks have gone so far as to refrigerate the cooked foodstuff to harden the grease, which is then removed.

As an alternative to these approaches, utensils specifically designed for dealing with the issue of excess oil and grease have been devised. One popular utensil is the cooking grill which allows the oil and fat to run off of the material being cooked. However, the grill surface is difficult to clean and requires additional care in both manufacturing and in handling.

An example of a purpose-specific frying pan assembly is set forth in U.S. Pat. No. 7,607,387, titled SYSTEM AND METHOD FOR DIVERTING LIQUIDS FROM FOODSTUFF DURING PREPARATION IN A FRYING PAN and issued on Oct. 27, 2009, to Edmund A. Stanczak, the same inventor as in the present invention. This invention provides certain valuable improvements over the prior art.

As in so many areas of technology, there is room for advancement in the art of cooking utensils.

### SUMMARY OF THE INVENTION

The disclosed invention provides a system and a method of using the system for directing liquids, particularly oils and grease in flowing form, away from foodstuff cooking in a frying pan. The system includes a frying pan having an integrally-formed extension formed on its underside, a frying pan supporting structure and an optional shield that prevents both splashing and splattering of oil and hot grease onto the user and on nearby surfaces as well such as the stovetop, the adjacent wall, and the floor. The frying pan supporting structure includes a bottom side for placement on a heating element and a top side upon which the frying pan extension nests. The bottom side and the top side are angled with respect to each other. The degree of angle can be of a variety of values, but in general the degree should be between about 3 degrees and 8 degrees.

The frying pan supporting structure includes an upper surface into which the extension of the frying pan nests. The supporting structure further includes a handle for manipulating the device. The oil or grease in flowing form substantially collects under the optional shield which prevents splashing and splattering. The shield may be made of a variety of configurations, but generally is a substantially flat sheet of a half-moon or triangular configuration and an element to retain the shield on the frying pan, such as a hook. The shield may be fitted with a wall. The user positions the shield at the low end of the angled frying pan. During use the oil and grease escaping from the foodstuff is directed by gravity to the lowest end of the frying pan, which is that area substantially under the shield.

The present invention offers several advantages over the prior art. The frying pan itself can be furnished with an optimum design to provide (1) minimized puddle size, (2) maximized cooking area, and (3) lowered assembly height. The splatter shield may be designed specifically for use with the furnished pan based on the angle of the pan walls and depth of the pan.

The present invention manages the grease generated during food preparation. The inventive concept includes a specialized pan, an angled support, and an optional splatter shield.

The specialized pan may be of a variety of sizes and dimensions but is preferably one of a 12-inch pan which incorporates a 8.25-inch diameter by 0.188-in thick extension attached to the bottom pan or a 10-inch pan which incorporates a 6.25-inch diameter by 0.188-inch thick extension attached to the bottom of pan. With respect to the extension itself, a thin stainless steel coating protects it from corrosion and wear, its thermally conductive core promotes heat transfer into food, and the extension's 6.25-inch OD into the angled support ring ID provides an elegant method of retaining pan. In addition, the extension may be formed as part of the pan or may be impact bonded to the pan, a manufacturing technique used on many current production pan designs. As one possible alternative the extension may be machined from the base of a pan initially manufactured with a thickened base. Furthermore, a tapered edge reaching out from the Pan 6.25-inch diameter can be added if obtaining a smooth thermal and/or structural transition from the pan bottom extension to the pan sidewall is determined to be required.

The supporting structure may be made from a variety of materials including but not limited to stainless steel pipe. The supporting structure may be made in any thickness or width as needed to maximize thermal efficiency. The frying pan itself incorporates an angle between the pan sidewall and the pan cooking surface that is close to 90-degrees. This angle provides the following. First, it maximizes the pan cooking area. Second, it provides the widest and deepest area into which grease can migrate, thus minimizing the grease puddle size.

It is preferred that the optional splash shield be provided with the pan so as to provide optimal fit, thus minimizing grease splatter.

Importantly and to emphasize the broad utility and versatility of the present invention, the system is designed to work on the gas, electric and radiant glass cooktops found in the vast majority of 110-million American households. Cooking on gas and electric cooktops presents no issues. Conventional cooking on radiant cooktops requires contact between the pan and cooktop glass. Angled cooking raises the pan slightly above this glass presenting an issue. The system addresses this issue as follows. On radiant cooktops an enclosed chamber is formed under the pan by the (1) pan bottom, (2) angled support ring and (3) cooktop glass. This chamber acts as a mini-oven located beneath the pan that is superheated by the heating elements, thus eliminating the need for this contact.

Device thermal performance is enhanced through the judicious use of materials. For example, copper conducts heat 29 times more efficiently than stainless steel. This makes stainless steel almost an insulator relative to copper. Productive heat transfer upward into the food is maximized by the pan extension's conductive copper core. Wasted heat transferred laterally through the angled support ring is minimized since it is fabricated from insulating stainless steel. Each material does its job to enhance device thermal performance.

Device thermal performance is enhanced by moving the pan bottom a total of 0.438-inches closer to the cooktop heating source as follows. (1) Angled support height was reduced 0.25-inches since the ring retention tabs were eliminated. (2) Pan bottom extension reaches down 0.188-inch into the ring hole. These two items add up to 0.438-inches.

Device stability is enhanced as follows. (1) Angled support height could be reduced 0.25-inch since the retention tabs were eliminated. (2) Low position of pan's bottom extension lowers assembly center of gravity.

Device stability is enhanced as follows. During conventional cooking, pans are set directly on cooking elements. Pans will wobble if the pan and/or the stovetop is warped. During angled cooking, angled support fits between the pan and the stovetop. This forces contact between these two components outward along the 6.25-inch ring diameter. Moving this contact line outward results in an assembly that is more resistant to wobble.

Device stability is enhanced as follows. Handles on current production pans are elevated above the cooktop by attaching a curved and/or an upwardly angled handle to the pan sidewall. In contrast, device attaches a straight handle to the pan sidewall and uses the device's 7.5-degree angle to achieve this elevation. This allows device overall height to closely match that of current production pans despite the angled support being located below pan.

Device features an integrated and esthetically pleasing look due to all of the following being oriented at the same 7.5-degree angle. (1) Top of angled support and angled support handle. (2) Pan and pan handle.

Fit between pan's bottom extension OD and angled support ring ID was chosen to provide the following. (1) Loose enough to easily install pan onto angled support. (2) Tight enough to properly retain pan on the angled support. (3) Loose enough to insure thermal expansion will not lock-up these components.

Contact between the pan's bottom and the angled support ring occurs along the 7.5-degree oriented plane. Moving the pan left, right, fore and aft along this plane does not affect contact between these components. As a result, the device's thermal performance and the pan's retention are also not affected.

One pan meal preparation involves initially cooking meat on an angle to remove grease then completing the meal horizontally. An example is cooking a product such as Hamburger Helper® as follows. (1) Cook hamburger on an angle using device. (2) Remove splatter shield and grease from the pan. (3) Remove the angled support. (4) Add Hamburger Helper® ingredients and use the furnished pan to finish cooking horizontally.

The disclosed system provides health benefits by reducing calories. Specifically, the device provides healthier meals by reducing the high fat and caloric content of fried food. Conscientious cooks try to deal with this problem in a number of ways to include. (1) Absorbing grease using paper towels. (2) Draining grease using colanders. (3) Pouring grease from the pan with the lid loosely installed. These techniques are reactive solutions that attempt to address the problem after the food has been cooked. These post-cooking approaches are ineffective and messy since at this point the food is completely saturated with grease due to being immersed in a puddle of boiling grease while being cooked. In contrast, the device provides a proactive solution that uses gravity to remove the grease during the cooking process. Simple observation shows that the prepared food has been transformed into a healthier alternative. Testing has shown that the device will remove more than two ounces of grease containing more than 500 calories from a pound of ground beef.

The disclosed system reduces cleanup time. Specifically, the device virtually eliminates grease splatter. This is accomplished since the grease has been moved from the cooking area and deposited underneath the optional splatter shield. Note that while the device is preventing splatter, the cook can view and access the cooking food with utensils since it remains uncovered. Contrast this with currently available splatter screens that completely cover the pan. They interfere with cooking since they block the cook's view of food and must be removed to access the food. Note further that when the screen is removed the stovetop ends up being splattered anyway.

The disclosed system reduces the costs of meals. This is accomplished by allowing inexpensive fatty grades of meat to be substituted for more expensive leaner grades with little difference in fat content or taste. Note that this price difference can be more than double between the two grades. Cooking high-fat content beef using the device provides the consumer with the ideal combination of a low-fat meal at a low-price. It is a win-win for the customer who can shop cheap and eat rich. This cost savings quickly adds up to pay for the device then provides big savings for the family. The disclosed system may easily find application as well for the cooking of other high-fat content meats such as bacon and sausage. This utility may well extend to preparing vegan dishes which use cooking oil.

The disclosed system reduces operator and kitchen complexity. Numerous countertop plug-in gadgets such as convection ovens, air fryers, electric skillets, rotisseries and microwaves are offered for today's kitchens. These gadgets often employ complex controls and Owner's Manuals that look like they were written by NASA. Most cooks can relate to struggling with the intricacies buried in a microwave keyboard. In contrast the device is small, lightweight and intuitively simple.

Other advantages and features of the embodiments of the invention will become apparent when viewed in light of the detailed description of the preferred embodiment when taken in conjunction with the attached drawings and the appended claims.

### BRIEF DESCRIPTION OF THE DRAWINGS

For a more complete understanding of this invention, reference should now be made to the embodiment illustrated in greater detail in the accompanying drawings and described below by way of examples of the invention wherein:

FIG. 1 is a side view of the frying pan system according to the disclosed invention including the specialized frying pan and the associated supporting structure;

FIG. 2 is a perspective view of the underside of the system comprising the specialized frying pan and associated supporting structure of FIG. 1;

FIG. 3 is a perspective view of the frying pan supporting structure according to the disclosed invention;

FIG. 4 is a side view of the frying pan supporting structure of FIG. 3;

FIG. 5 is a side view of the specialized frying pan of FIG. 1;

FIG. 6 is a perspective view of the underside of the specialized frying pan;

FIG. 7a is a sectional view of the frying pan extension integral with the underside of the frying pan of the disclosed inventive concept in which the profile of the corner of the edge of the extension is squared;

FIG. 7b is a sectional view of the frying patent extension illustrating a rounded corner edge profile;

FIG. 7c is a sectional view of the frying patent extension illustrating a 45° degree cut edge profile;

FIG. 7d is a sectional view of the frying patent extension illustrating a corner edge profile which transitions from a tapered, first lower level to a squared higher level;

FIG. 8 is a perspective view of a splash shield of the present invention; and

FIG. 9 is perspective view of the system of the disclosed invention in which the specialized frying pan, the supporting structure, and the splash shield are shown in an as-used stacked configuration.

### DETAILED DESCRIPTION OF THE PREFERRED EMBODIMENT

In the following figures, the same reference numerals will be used to refer to the same components. In the following description, various operating parameters and components are described for one constructed embodiment. These specific parameters and components are included as examples and are not meant to be limiting.

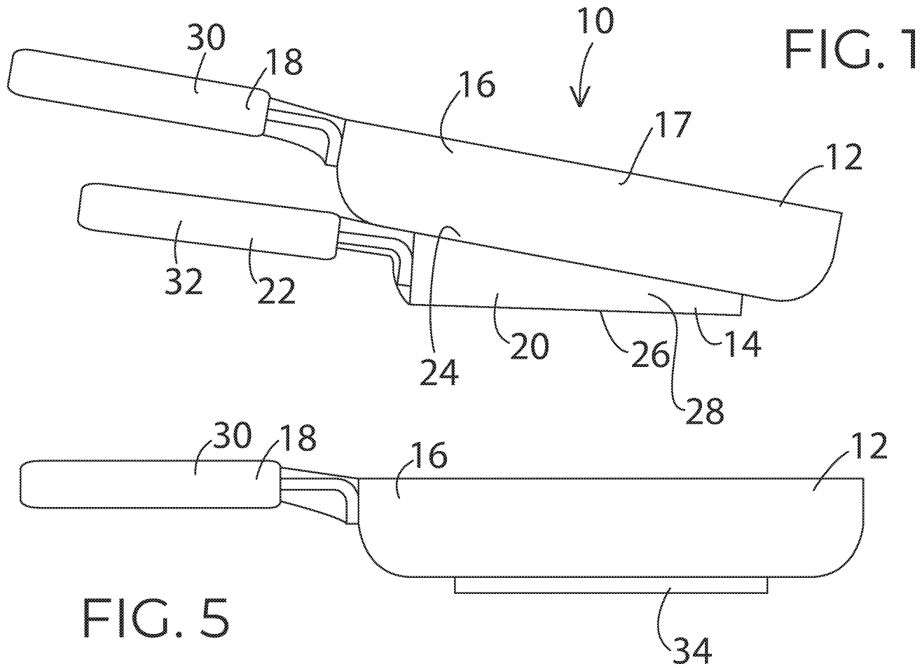

With reference to FIG. 1, a perspective view of a system for managing grease from foodstuff during preparation in a frying pan, generally illustrated as 10, is shown. The system 10 includes a specialized frying pan 12 and a supporting structure 14. The specialized frying pan includes a side wall 16, a body 17, and a handle 18. The supporting structure 14 includes a body 20 and a handle 22.

In the various views set forth herein the body 20 is illustrated as having a ring configuration as such a configuration may be the most desirable. However, it is to be understood that other configurations, such as a square, rectangular, triangular, octagonal, or other shape may be used as well provided it will be possible for the frying pan 12 to mate with the upper surface of the supporting structure 14 as described below. Regardless of the shape, the body 20 is composed of an easy to clean and durable metal material, such as stainless steel.

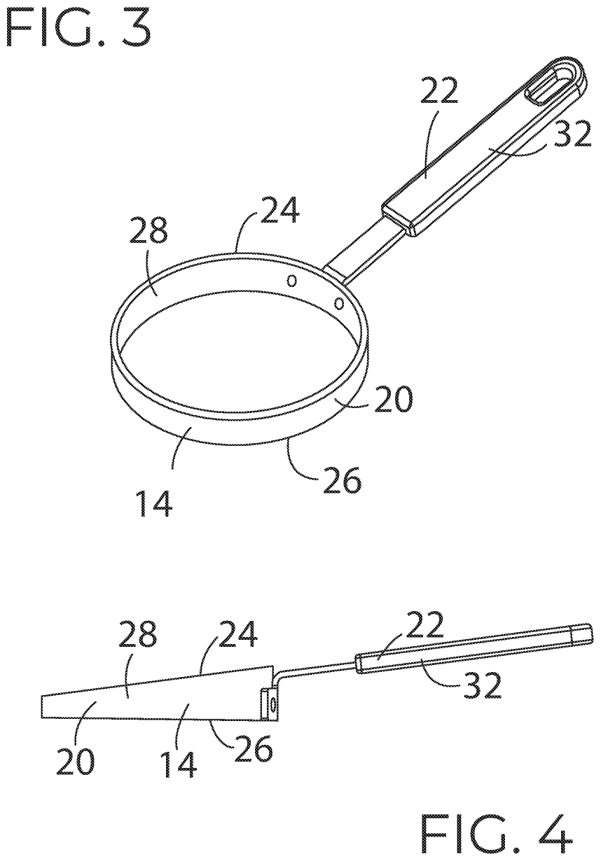

As set forth also in FIGS. 3 and 4 which illustrate the supporting structure 14 in isolation, the body 20 of the supporting structure 14 includes a top, frying pan-supporting side 24, and a bottom, heating element-contacting side 26. A wall 28 is formed between the top side 24 and the bottom side 26. The height of the wall 28 is greater at one end of the body 20 than at the other end. This difference in height defines the planar structure of the body 20. The angle between the top side 24 and the bottom side 26 may be any of a variety of angles, but the angle must at least be great enough to cause a flow of oil and grease from the higher end of the frying pan 12 where the foodstuff is being prepared to the lower end of the frying pan 12 where the oil and grease are being gathered. The angle, however, must not be great enough so that the foodstuff itself moves toward the lower end of the frying pan and must not be so shallow that the grease puddle becomes excessively wide. The preferred angle is between about 3 and 8 degrees. In addition, it is to be understood that while the angle of the handle 22 relative to the wall 28 of the body 20 of the supporting structure 14 is illustrated as being approximately 97.5°, the angle may be otherwise such as but not exclusively 90.0°.

The handles 18 and 22 are provided to facilitate movement by the user of the frying pan 12 and the supporting structure 14 respectively either individually or as a unit. The handles 18 and 22 as illustrated are exemplary but not limiting as other handle configurations may be used. As is known the handle 18 may or may not include an insulating portion 30 that is held by the user. Similarly, the handle 22 may or may not include an insulating portion 32 that is held by the user. The handle 18 of the frying pan 12 is fixed to the body 17 by mechanical fastening such as by screws or rivets. It may alternatively be fastened to the body 17 by welding. Similarly, the handle 22 of the supporting structure 14 is fixed to the body 20 by mechanical fastening such as by screws or rivets. Again, it may alternatively be fastened to the body 20 by welding.

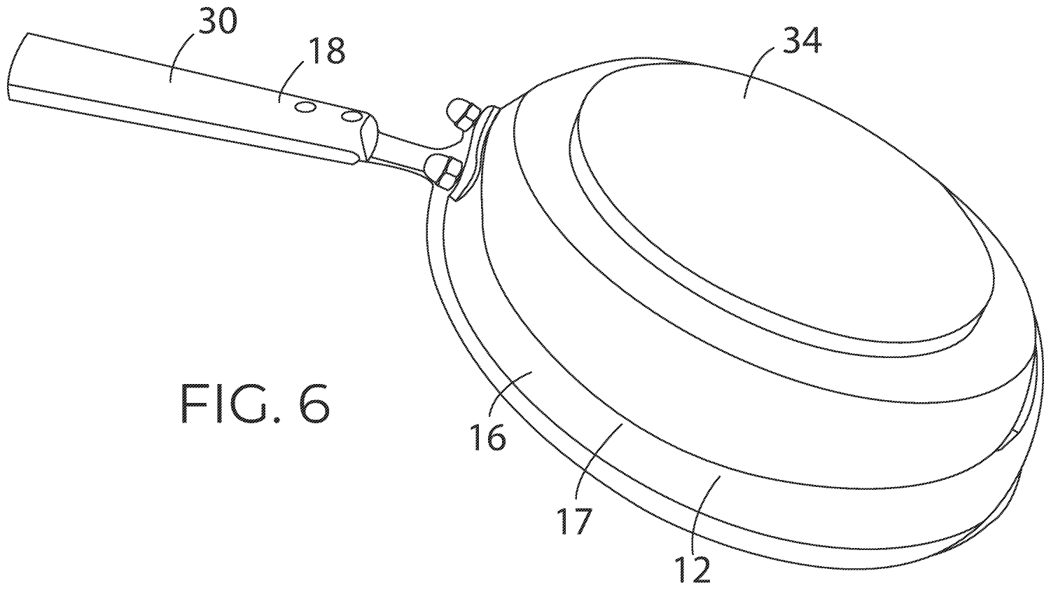

The specialized frying pan 12 of the disclosed inventive concept is configured so as to rest on top of the supporting structure 14 without moving off of the supporting structure 14 once in position. To eliminate any side-to-side movement of the frying pan 12 once in position on the upper surface 24 of the supporting structure 14, an extension 34 is integrally formed on the underside of the frying pan 12 as illustrated in FIGS. 5 and 6. The extension 34 may be cast with the frying pan 12 upon construction or may be added to an existing frying pan by any of several known methods. Alternatively, the extension may be machined from the base of a pan initially manufactured with a thickened base.

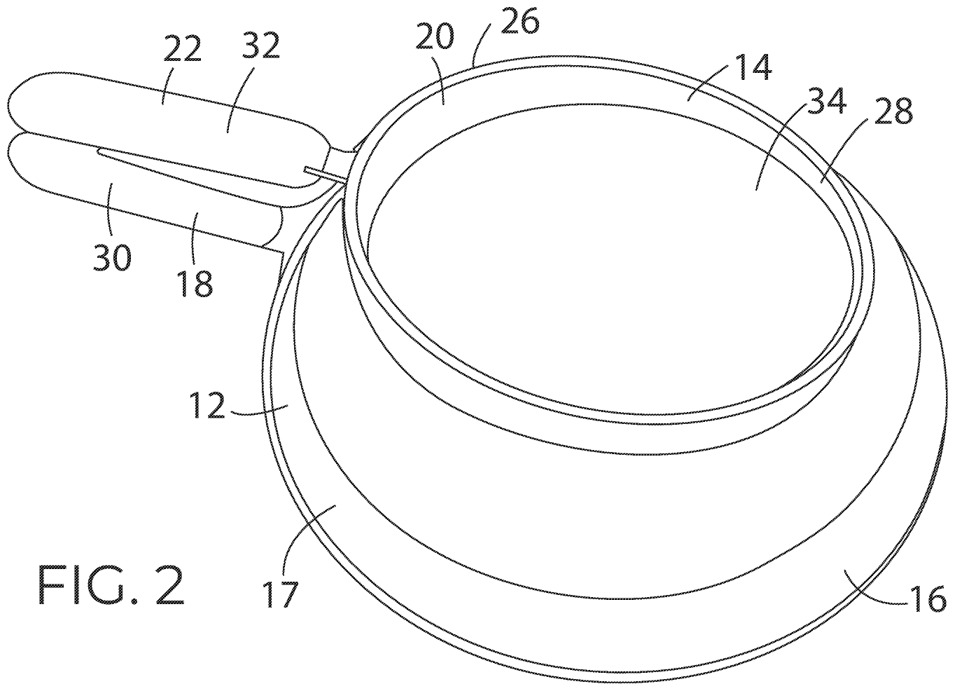

The extension 34 is shaped so as to essentially nest within the interior of the upper portion of the supporting structure 14. This is accomplished by configuring the outer diameter of the extension 34 so as to be slightly less than the inner diameter of the upper end of the supporting structure 14. The nesting arrangement of the extension 34 relative to the supporting structure 14 may be seen in FIG. 2.

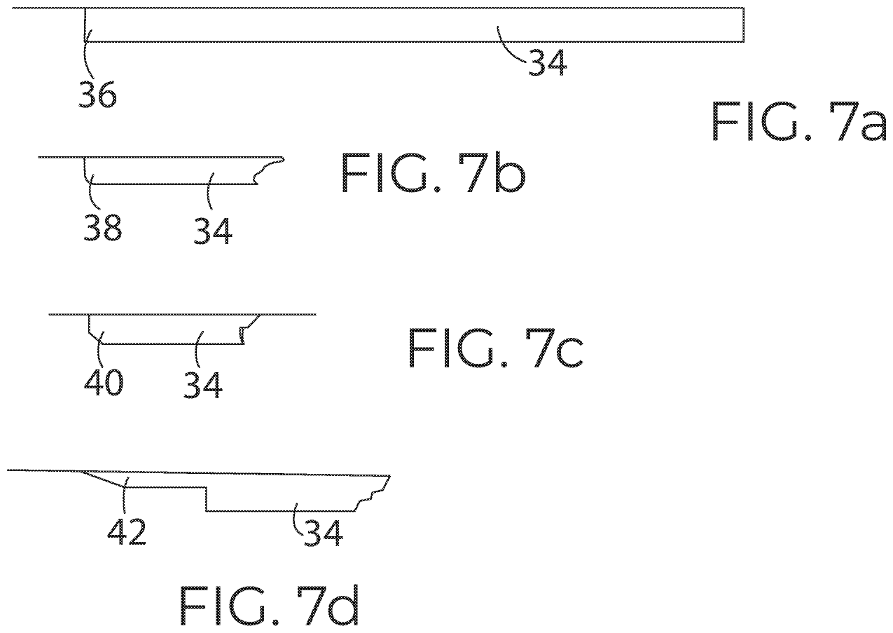

Various profiles of the edge of the extension 34 are possible. Preferred but not limiting profiles are illustrated in FIGS. 7a, 7b, 7c, and 7d. Referring to FIG. 7a, a sectional view of the frying pan extension 34 integral with the underside of the frying pan of the disclosed inventive concept is shown. In this figure, a squared edge 36 is illustrated. A variation of the extension edge is illustrated in FIG. 7b as a rounded corner 38. A further variation of the extension edge is illustrated in FIG. 7c as a 45° degree cut edge profile. Yet another variation of the extension edge is illustrated in FIG. 7d in which the corner edge 42 includes a configuration which transitions from a tapered, first lower level to a squared higher level. The edge profile variations illustrated in FIGS. 7a, 7b, 7c, and 7d are intended as being suggestive and not limiting.

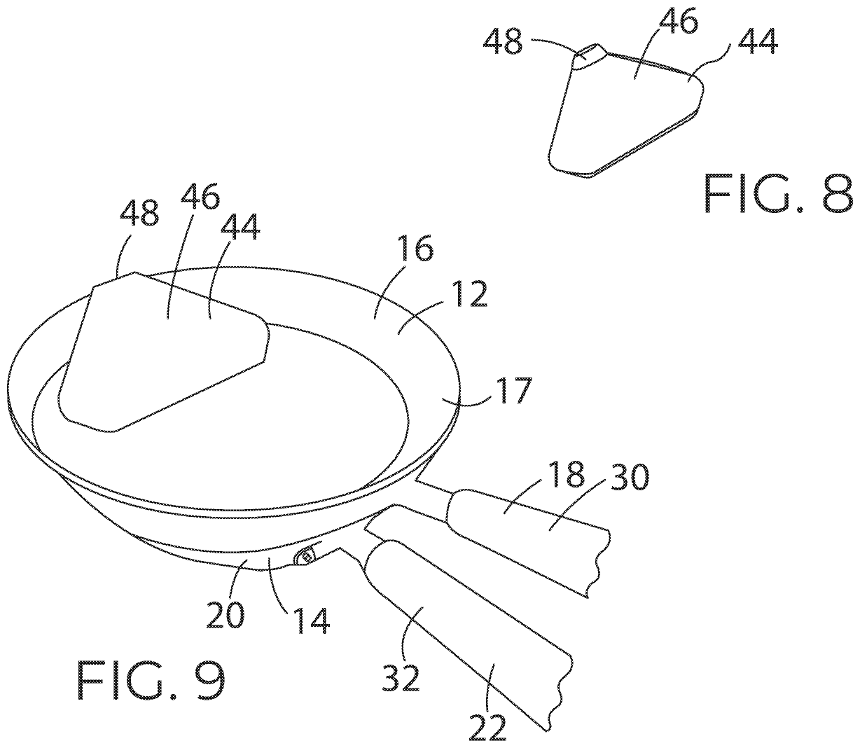

To provide against the splashing or splattering of grease, a shield 44 illustrated in perspective view in FIG. 8 may optionally but preferably be provided. The shield 44 includes a planar, half-moon-shaped or triangular-shaped body 46 having a hook 48 for placement at one end of the side wall 16 of the frying pan 12 as illustrated in FIG. 9. Regardless of its shape, the shield 44 is preferably profiled to closely fit the profile of the frying pan 12 thereby optimizing splash reduction. The configuration of the hook 48 may be altered as need to provide for frying pans having peripheral side walls 16 of different heights. A greater number of hooks may also be used. The shield 44 may be safely removed from the frying pan 12 by a kitchen utensil such as a fork. The thickness of the shield 44 is such that it may be fitted between the tines of the fork, thereby allowing the user to capture the shield 44 between the tines for removal of the shield 44. Alternatively, a slot (not shown) may be formed in the triangular-shaped body 46 for receiving a kitchen utensil.

In use, the user first places a selected frying pan supporting structure 14 on a heating surface. Next the user places the specialized frying pan 12 on the frying pan supporting structure 14 as illustrated in FIG. 1 such that the extension 34 nests within the upper end of the frying pan supporting structure 24. Once the frying pan supporting structure 14 is placed on the heating surface and the frying pan 12 is in place on the frying pan supporting structure 14, the shield 44 may be optionally positioned on the frying pan 12 as illustrated in FIG. 9.

An appropriate amount of cooking oil is placed on the base of the frying pan 12 and a foodstuff (not shown) is then placed on the high end of the angled frying pan 12. (Alternatively the cooking oil can be placed on the base of the frying pan 12 before the pan 12 is placed on the frying pan supporting structure 14. In addition, cooking oil may not be necessary depending on the interior surface of the pan 12. The foodstuff is then cooked and excess oil and resulting grease travels from the cooking area of the frying pan 12 to the low area covered by the optional shield 44. As a result of using the system of the present invention the cooked foodstuff has less grease, the user and the cook-top are not spattered by hot oil and grease, and clean-up can be readily accomplished by disposal of the gathered oil and grease into a tin can or other receptacle.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention.

I claim:

1. A system for managing grease during preparation of a foodstuff, the system comprising:
a frying pan having an underside, the underside having an extension, the extension having a wall, the wall having an outer dimension; and
a supporting structure having a lower surface, an upper surface, and a wall formed between the lower and upper surfaces, the upper surface being angled relative to the lower surface, the wall having an inner dimension, the outer dimension of the wall of the extension being less than the inner dimension of the wall of the supporting structure,
whereby the extension of the underside of the frying pan can substantially nest within the supporting structure.

2. The system for managing grease of claim 1, wherein the extension is integral with the frying pan whereby the material forming the extension is formed continuous with the frying pan.

3. The system for managing grease of claim 1, wherein the extension is formed separate from the frying pan and is attached thereto.

4. The system for managing grease of claim 1, wherein the preferred angle of the supporting structure is between about 3 and 8 degrees.

5. The system for managing grease of claim 1, wherein each of the frying pan and the supporting structure includes at least one handle attached thereto.

6. The system for managing grease of claim 5, wherein the handle attached to the supporting structure is set at an angle relative to the wall of the support structure.

7. The system for managing grease of claim 6, wherein the angle of the handle relative to the wall of the supporting structure is preferably at between about 90.0 and 97.5 degrees.

8. The system for managing grease of claim 1, further including a triangular-shaped splash shield for removable placement at one end of the frying pan.

9. The system for managing grease of claim 8, the splash shield including a hook for removable attachment to the frying pan.

10. A system for managing grease during preparation of a foodstuff, the system comprising:
a frying pan having an underside;
an extension, the disc-shape extension being attachable to the underside of the frying pan, the extension having a wall, the wall having an outer dimension; and
a supporting structure having a lower surface, an upper surface, and a wall formed between the lower and upper surfaces, the upper surface being angled relative to the lower surface, the wall having an inner dimension, the outer dimension of the wall of the extension being less than the inner dimension of the wall of the supporting structure,
whereby the extension of the underside of the frying pan can substantially nest within the supporting structure.

11. The system for managing grease of claim 10, wherein the extension is disc-shaped.

12. The system for managing grease of claim 10, wherein the preferred angle of the supporting structure is between about 3 and 8 degrees.

13. The system for managing grease of claim 10, wherein each of the frying pan and the supporting structure includes at least one handle attached thereto.

14. The system for managing grease of claim 13, wherein the handle attached to the supporting structure is set at an angle relative to the wall of the support structure.

15. The system for managing grease of claim 14, wherein the angle of the handle relative to the wall of the supporting structure is preferably at between about 90.0 and 97.5 degrees.

16. The system for managing grease of claim 10, further including a triangular-shaped splash shield for removable placement at one end of the frying pan.

17. The system for managing grease of claim 16, the splash shield including a hook for removable attachment to the frying pan.

18. A system for managing grease during preparation of a foodstuff, the system comprising:
a frying pan extension for use with a frying pan, the extension having a wall, the wall having an outer dimension; and
a supporting structure having a lower surface, an upper surface, and a wall formed between the lower and upper surfaces, the upper surface being angled relative to the lower surface, the wall having an inner dimension, the outer dimension of the wall of the extension being less than the inner dimension of the wall of the supporting structure,
whereby the extension can substantially nest within the supporting structure.

19. The system for managing grease of claim 18, wherein the extension is disc-shaped.

20. The system for managing grease of claim 18, wherein the extension is attached to the underside of the frying pan.
